(19) United States
(12) Patent Application Publication
(10) Pub. No.: US 2014/0053102 A1
(43) Pub. Date: Feb. 20, 2014

(54) TERMINAL AND METHOD FOR PROVIDING USER INTERFACE

(71) Applicant: PANTECH CO., LTD., Seoul (KR)

(72) Inventors: Zoo Hyun LEE, Seoul (KR); Hyoung Jin KIM, Seoul (KR); Se Young LEE, Seoul (KR)

(21) Appl. No.: 13/919,434

(22) Filed: Jun. 17, 2013

(30) Foreign Application Priority Data
Aug. 20, 2012 (KR) 10-2012-0090603

(51) Int. Cl. G06F 3/0482

(52) U.S. Cl. CPC G06F 3/0482
USPC 715/810

(57) ABSTRACT

A method for providing a user interface including displaying item information of an item on a first screen layer; displaying a first task selection menu corresponding to the item on a second screen layer; and overlaying the second screen layer on a portion of the first screen layer while displaying the item information as a whole. A terminal including a display unit including a first screen layer and a second screen layer, the first screen layer displaying item information of an item, and the second screen layer displaying a first task selection menu corresponding to the item; and a control unit to overlay the second screen layer on a portion of the first screen layer while the item information of the first screen layer is wholly displayed.

### CROSS-REFERENCE TO RELATED APPLICATION

This application claims priority to and the benefit under 35 U.S.C. §119(a) of Korean Patent Application No. 10-2012-0090603, filed on Aug. 20, 2012, the entire disclosure of which is incorporated by reference for all purposes.

### BACKGROUND

1. Field

The following disclosure relates to a terminal having an improved user interface function and a method for providing a user interface.

2. Discussion of the Background

Mobile communication terminals that have been released recently, such as smartphones and tablet personal computers (PCs) are configured to include a touchscreen to is allow a user to perform an operation more easily and simply.

However, the touchscreen included in the mobile communication terminal is physically limited in its size.

FIG. 1, FIG. 2, and FIG. 3 are diagrams illustrating a user interface screen provided by a mobile communication terminal including a touchscreen according to a related art.

As illustrated in FIG. 1, when Contacts or contact information registered in a Phonebook application are displayed, and when a user who wants to execute a task (for example, a Delete operation or task) presses or touches, for example, a menu button, a task selection screen is overlaid on the screen that displays items (for example, Contacts included in the Phonebook application) as illustrated in FIG. 2. However, there is a problem in that parts of the items displayed on the screen are covered or obstructed by the task selection screen.

In addition, when a particular task (for example, a Delete operation or task) is selected from the task selection screen, as illustrated in FIG. 3, checkboxes for selecting particular tasks to be executed are provided on the same screen. Therefore, there is a problem in that an item information region is reduced or parts of item information are omitted or cut.

In addition, according to the related art, an affordance that indicates that a mode for executing the task is insufficient when activated and the user may be in confusion. Therefore, there is a problem in the execution of the task.

In addition, according to the related art, a mobile communication terminal is implemented to execute only a single task at a time. Accordingly, for example, when three tasks including Move, Save, and Delete are to be executed on a message, the three tasks have to be separately executed. That is, in order to move a particular message to Universal Subscriber Identity Module (USIM) or the like, a Move operation or task is first selected, the message to be is moved is thereafter selected, and the selected message is moved to USIM or the like by executing the Move operation or task. In order to save a particular message, a Save operation or task is first selected, the message to be saved is thereafter selected, and the selected message is saved in a storage box by executing the Save operation or task. In order to delete a particular message, a Delete operation or task is first selected, the message to be deleted is thereafter selected, and the selected message is deleted by executing the Delete operation or task.

As described above, since only a single task is executed at a time according to the related art, there is a problem in that the same procedures of selecting a task to be executed, selecting an item, and the like have to be repeated by the number of tasks to be executed.

### SUMMARY

Exemplary embodiments of the present invention provide a terminal having an improved user interface function and a method for providing a user interface.

Additional features of the invention will be set forth in the description which follows, and in part will be apparent from the description, or may be learned by practice of the invention.

Exemplary embodiments of the present invention provide a method for providing a user interface including displaying item information of an item on a first screen layer; displaying a first task selection menu corresponding to the item on a second screen layer; and overlaying the second screen layer on a portion of the first screen layer while displaying the item information as a whole.

Exemplary embodiments of the present invention provide a terminal including a display unit including a first screen layer and a second screen layer, the first screen layer is displaying item information of an item, and the second screen layer displaying a first task selection menu corresponding to the item; and a control unit to overlay the second screen layer on a portion of the first screen layer while the item information of the first screen layer is wholly displayed.

Exemplary embodiments of the present invention provide a method for providing a user interface including displaying item information of an item on a first screen layer;

displaying a first task selection menu and a second task selection menu corresponding to the item on a second screen layer; overlaying the second screen layer on a portion of the first screen layer while displaying the item information as a whole; receiving a selection of at least one of the first task selection menu and the second task selection menu; and executing at least one of the selected task selection menus.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a user interface according to related art.

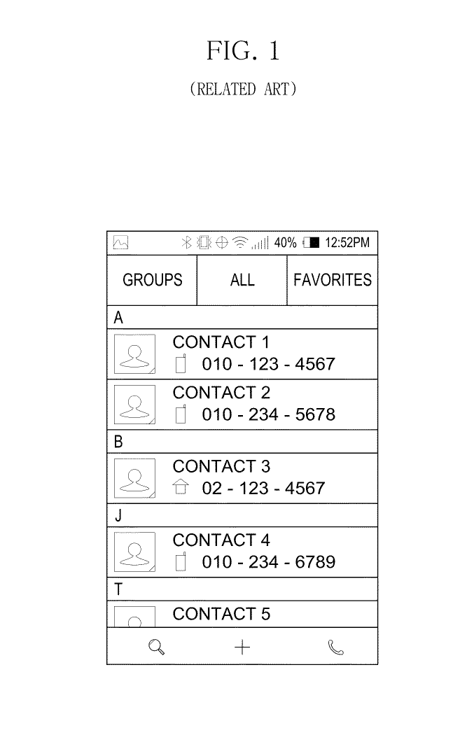

FIG. 2 is a diagram illustrating a user interface with an operation menu according is to related art.

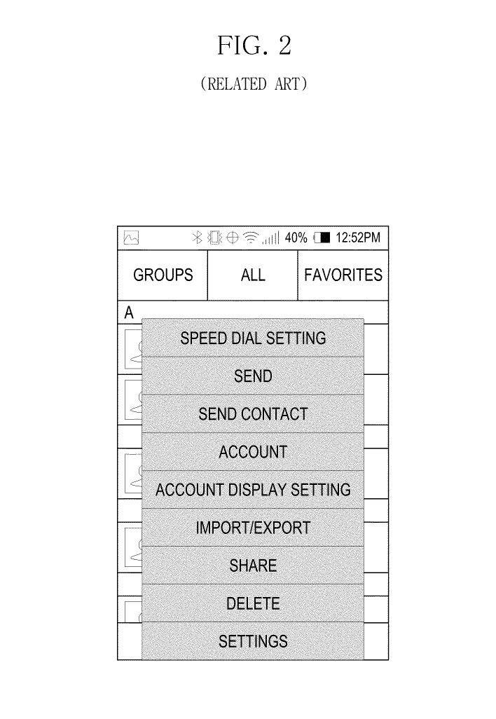

FIG. 3 is a diagram illustrating a user interface with task checkboxes according to related art.

FIG. 4 is a diagram illustrating task checkboxes overlaid on a user interface according to exemplary embodiments of the present invention.

FIG. 5 is a diagram illustrating task checkboxes overlaid on a user interface according to exemplary embodiments of the present invention.

FIG. 6 is a diagram illustrating task checkboxes overlaid on a user interface according to exemplary embodiments of the present invention.

FIG. 7 is a diagram illustrating task checkboxes overlaid on a user interface according to exemplary embodiments of the present invention.

FIG. 8 is a diagram illustrating an operation to display hidden task checkboxes to be overlaid on a user interface according to exemplary embodiments of the present invention.

FIG. 9 is a diagram illustrating an operation to display layers of task selection menu over laid on a user interface according to exemplary embodiments of the present invention.

FIG. 10 is a diagram illustrating an operation for selecting task checkboxes to be displayed according to exemplary embodiments of the present invention.

FIG. 11 is a diagram illustrating an operation to control a display of a task checkbox according to exemplary embodiments of the present invention.

FIG. 12 is a diagram illustrating an operation to control a display of a task checkbox according to exemplary embodiments of the present invention.

FIG. 13 is a schematic diagram illustrating a configuration of a mobile communication terminal according to exemplary embodiments of the present invention.

FIG. 14 is a diagram illustrating a method for selecting tasks according to exemplary embodiments of the present invention.

FIG. 15 is a diagram illustrating a method for selecting tasks according to exemplary embodiments of the present invention.

FIG. 16 is a flowchart illustrating a method for providing a user interface according to exemplary embodiments of the present invention.

FIG. 17 is a diagram illustrating a display of checkboxes on a user interface according to exemplary embodiments of the present invention.

FIG. 18 is a diagram illustrating a task of designating a recipient and a carbon copy for transmission of contact information according to exemplary embodiments of the present invention.

FIG. 19 is a diagram illustrating tasks capable of being performed on images according to exemplary embodiments of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other to features from one or more exemplary embodiments.

A term of an item may refer to an individual element of an arbitrary set, and may correspond to one or more messages that may be registered in at least one of a Message box, photographs registered in a Gallery program, contact information registered in a Phonebook (or an Address book) program, or the like. Further, item information may refer to information of the item, and may not include excess space that may be disposed within a reference proximity of the item, such as blank space. For example, for a row displaying “ITEM” as item information, the item information may not include excess blank space that follows the item information of “ITEM”.

A task may be referred to as a basic unit of a program controlled by an operating system (OS), and may refer to an operation or function of a program or OS. A task may correspond to at least one of a Delete operation, a Move operation, a Copy operation, or the like for a message. Further, the task may correspond to a Delete operation, a Rotate left operation, a Rotate right operation, a Share operation, a Copy operation, a Print operation, or the like for a photograph. The task may correspond to a Delete operation, an Edit operation, a Send operation with respect to an email, a message, and a contact, or the like for contact information.

A first screen layer may refer to a screen layer, which may display a list of items that belong to a set. For example, at least one of a message list, a photograph list, a contact list, or the like may be displayed on the first screen layer.

A second screen layer may refer to a screen layer, which may be overlaid on a part or the entirety of the first screen layer. The second screen layer may include at least one or more task checkboxes, which may be overlaid and displayed on the first screen layer such that a portion of the first screen is displayed along with at least a portion of the second screen.

As described above, the second screen layer may be overlaid on the first screen layer. Further, the second layer may be implemented to be displayed to be transparent or translucent to reduce an effect on items displayed on the first screen layer.

The task checkbox may be a selection menu corresponding to an item. The task checkbox may be selected for execution for the selected item. However, aspects of the invention is are not limited thereto, such that selection menu may include radio buttons, drop down menus, hyperlinks, open fields and the like may be used. A terminal may include, without limitation, a mobile terminal, a tablet computer, a desktop personal computer (PC), a laptop PC, and the like.

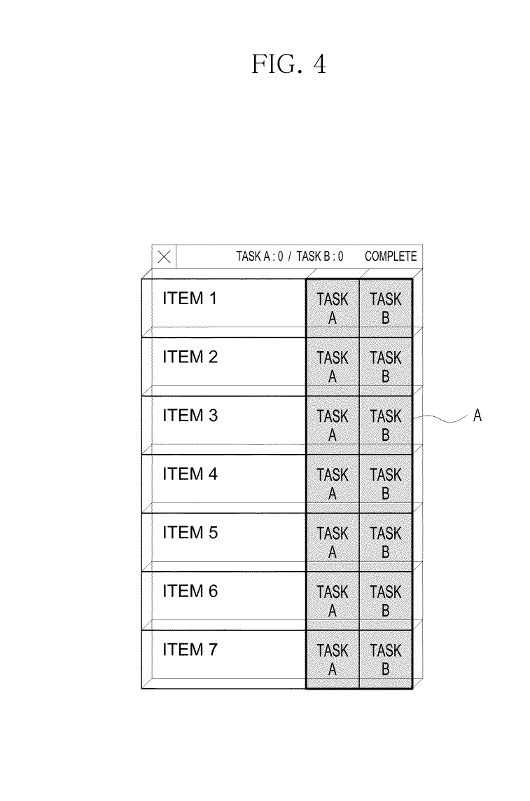

FIG. 4 is a diagram illustrating task checkboxes overlaid on a user interface according to exemplary embodiments of the present invention. Task checkbox A and other task checkboxes may be provided to be matched to items as illustrated in FIG. 4.

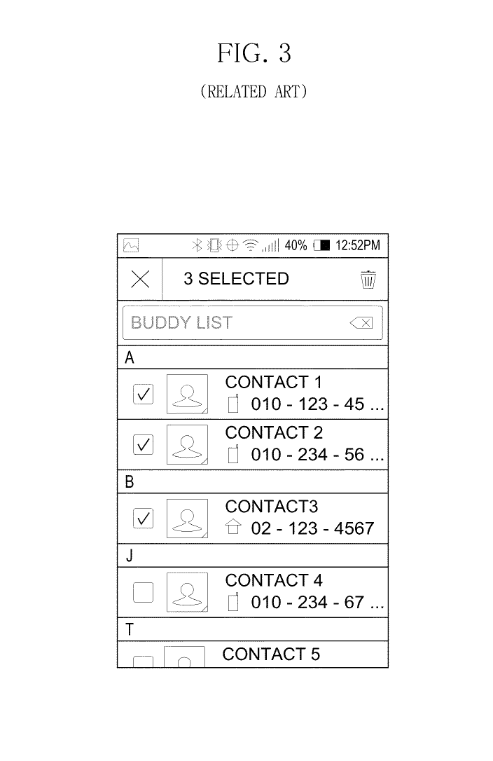

As illustrated in FIG. 4, item information is wholly displayed on a first screen layer, and task checkboxes are displayed on a second screen layer. The task checkboxes of the second screen layer are overlapped on or over a portion of the first screen layer while the item information of the first screen layer may be wholly displayed. Accordingly, all of the item information may be displayed as opposed to having a portion of the item information being hidden as illustrated in FIG. 3.

In addition, regarding the task checkbox, a task checkbox may include one or more tasks that may be provided to correspond to an item, such that one or more tasks may be selected for at least one item.

In addition, regarding the task checkbox, a task checkbox may include the same number of tasks as or less than the number of all the tasks that may be available to be executed for an item may be provided for the respective item.

Further, in the header section, number of tasks corresponding to TASK A and number of tasks corresponding to TASK B that may be selected for execution may be displayed. After selection of relevant tasks, the selected tasks may be executed when a user presses or touches on the “COMPLETE” control mechanism.

Although task checkboxes are illustrated as being provided in columns, aspects of is the invention are not limited thereto. The task check boxes may be provided as rows, or independently for each item. For example, if Task A is not applicable for Item 7, only Task B may be displayed for Item 7 or Task A may not be available for selection.

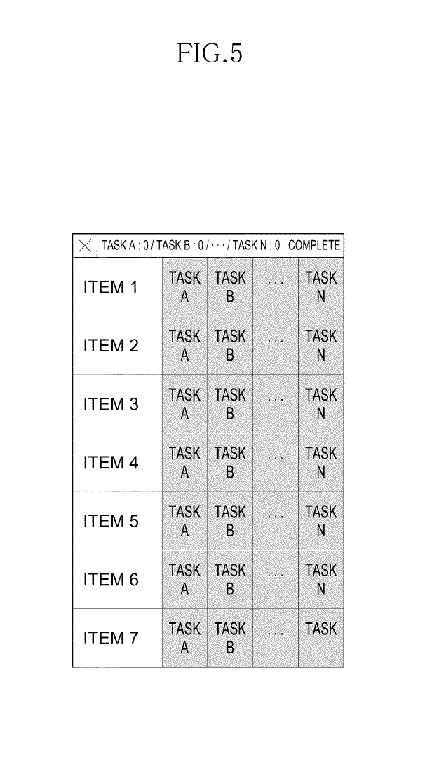

FIG. 5 is a diagram illustrating task checkboxes overlaid on a user interface according to exemplary embodiments of the present invention.

More specifically, as illustrated in FIG. 5, when a total of N tasks (for example, Delete, Move, Copy, and the like) are able to be executed for a particular item (for example, message), multiple task checkboxes corresponding to a total of N tasks may be provided to be matched to the message items. The items or item information displayed on the first screen layer may be wholly displayed when the task checkboxes of the second screen layer is overlaid on the first screen layer. The number of task checkboxes that may be displayed may be based on at least one of user preference, effective visibility, and the like. If the number of task checkboxes are larger than what may be displayed on a single screen, the information of the second screen layer may be scrolled to the left and right to display other task checkboxes while the information of the first screen layer remain fixed.

In addition, regarding the task checkbox, one or more tasks selected by a user from all the tasks that may be available for an item may be available to be executed for the respective item. The selected tasks may be performed sequentially or simultaneously when a user selects on the COMPLETE control mechanism displayed in the header section.

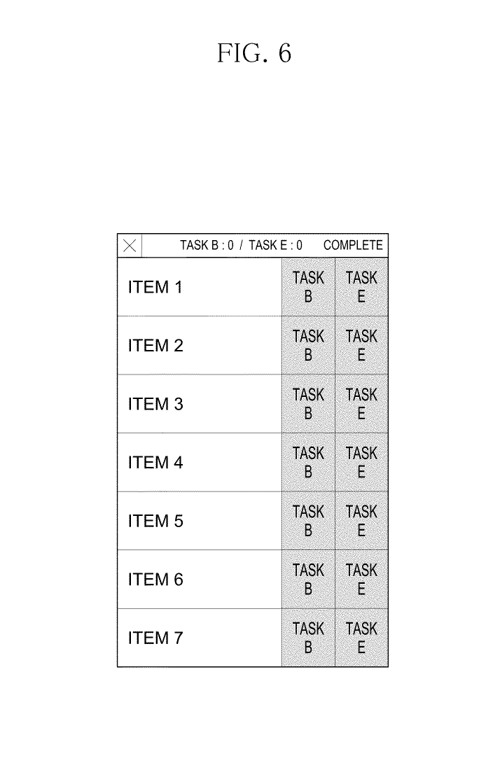

FIG. 6 is a diagram illustrating task checkboxes overlaid on a user interface according to exemplary embodiments of the present invention.

More specifically, as illustrated in FIG. 6, when a total of 5 tasks including A, B, C, D, and E may be available for the tasks that may be executed for an item, and the user selects is only two tasks including B and E therefrom, a task checkbox including the tasks B and E may be provided to be matched to the items.

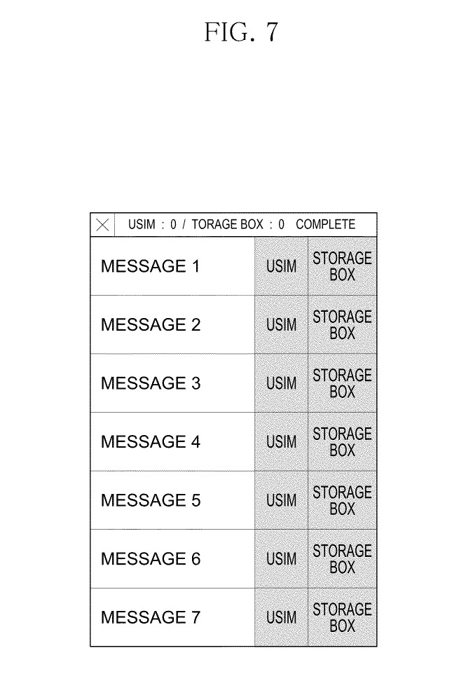

In addition, regarding the task checkbox, as illustrated in FIG. 7, a task checkbox including two or more tasks may be grouped by similarity in function is provided to be matched to items.

FIG. 7 is a diagram illustrating task checkboxes overlaid on a user interface according to exemplary embodiments of the present invention.

For example, a function or task of moving a message to Universal Subscriber Identity Module (USIM) and a function or task of storing a message in a storage box may be similar to each other. Referring to FIG. 7, the two functions may be grouped to be provided to allow a capability of selecting for execution the function or task of moving to USIM and the function or task of storing in the storage box on a single screen. When the user selects the COMPLETE control mechanism, the two functions or tasks may be submitted for execution in a single request.

In addition, a Send message function and a Send email function may be similar to each other. Therefore, the two functions or tasks may be grouped to be provided to allow a capability of selecting for execution the Send message function and the Send email function on a single screen. When the user selects the COMPLETE control mechanism, the two functions or tasks may be submitted for execution in a single request.

In addition, a Rotate right function and a Rotate left function of a photograph program may be similar to each other. Therefore, the two functions may be grouped to be provided to allow a capability of selecting for execution the Rotate right function and the Rotate left function on a single screen.

The task checkbox may be implemented in various manners. Further, although not illustrated, if multiple task checkboxes are available, which may be viewed through a scrolling operation (e.g., by scrolling left or right), the task checkboxes that may be displayed through a scrolling operation may be considered as part of the single screen.

As described above, the task checkbox may be displayed on the second layer and overlaid on the first screen layer. Further, the task checkbox of the second layer may be overlaid on the first screen layer to correspond to the items according to a user input for task selection.

Various inputs may be provided as the user input for making a task selection. The various inputs may include, without limitation, a menu button input, a dragging (e.g., an operation of dragging one portion of a screen towards a different portion of the screen with a finger or a utensil for a predetermined time), a swiping operation (e.g., an operation of providing an input at a portion of a screen and providing swiping motion from the inputted portion towards a particular direction with a finger), a tapping operation of the user, a long touch or press input on a touchscreen, and the like.

Hereinafter, a state where a task checkbox of the second screen being overlaid on the first screen layer according to a user input will be described in more detail as follows.

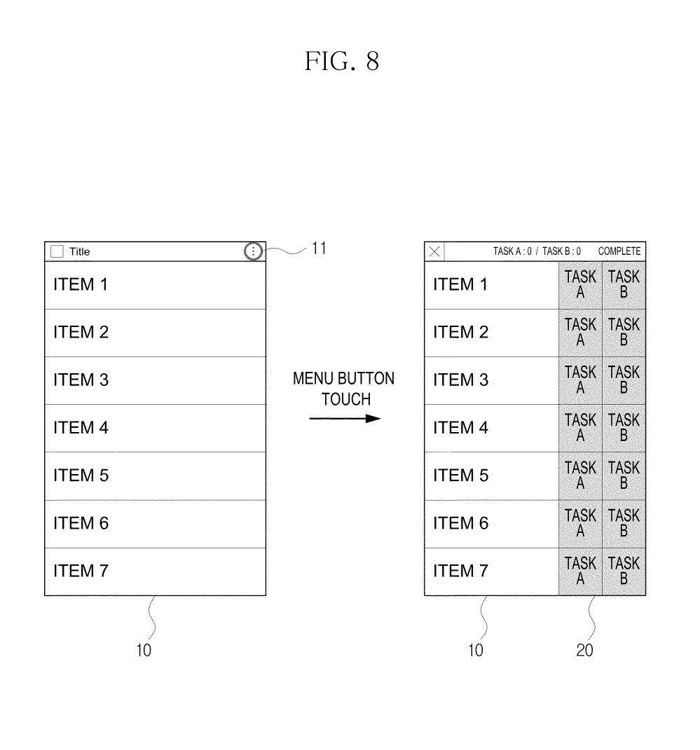

FIG. 8 is a diagram illustrating an operation to display hidden task checkboxes to be overlaid on a user interface according to exemplary embodiments of the present invention.

As illustrated in FIG. 8, when the user touches a menu button 11 when a plurality of items are displayed on a first screen layer 10, a task checkbox displayed on a second screen layer 20 is overlaid on the first screen layer 10. The task checkbox of the second screen layer 20 may be overlaid on the first screen layer 10, such that the task checkbox is overlaid to match items of the first screen layer 10.

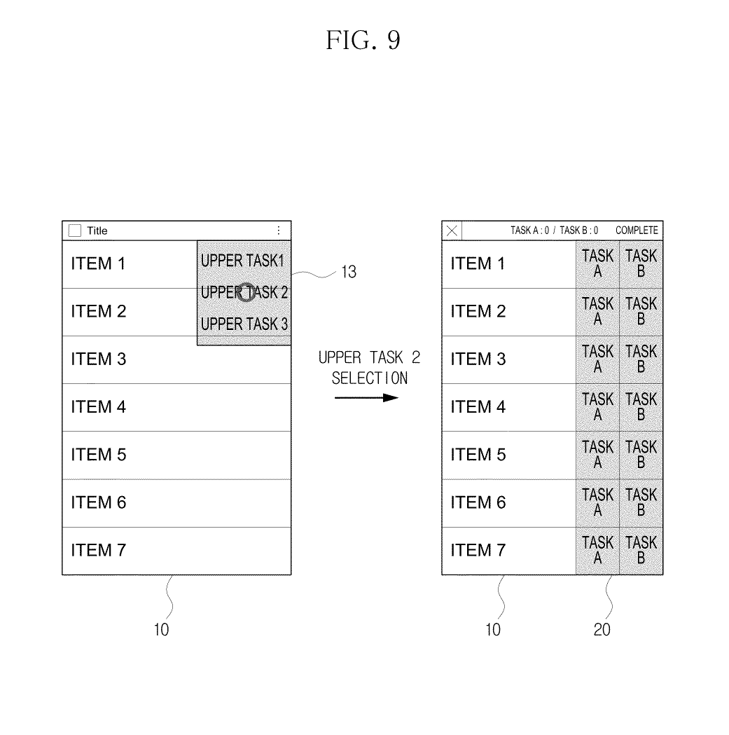

FIG. 9 is a diagram illustrating an operation to display layers of task selection menu over laid on a user interface according to exemplary embodiments of the present invention.

In addition, as illustrated in FIG. 9, when an item is selected from an upper task list or a task grouping menu (e.g., an upper task list for upper tasks grouped by similarity in function) 13, task checkboxes of the second screen layer 20 including two or more grouped tasks is overlaid on the first screen layer 10 and the task check boxes may be overlaid to be matched to the items of the first screen layer 10. The upper task list 13 may be provided in response to selection of a menu button input. Further, the upper task list 13 includes Upper Task 1, Upper Task 2, and Upper Task 3.

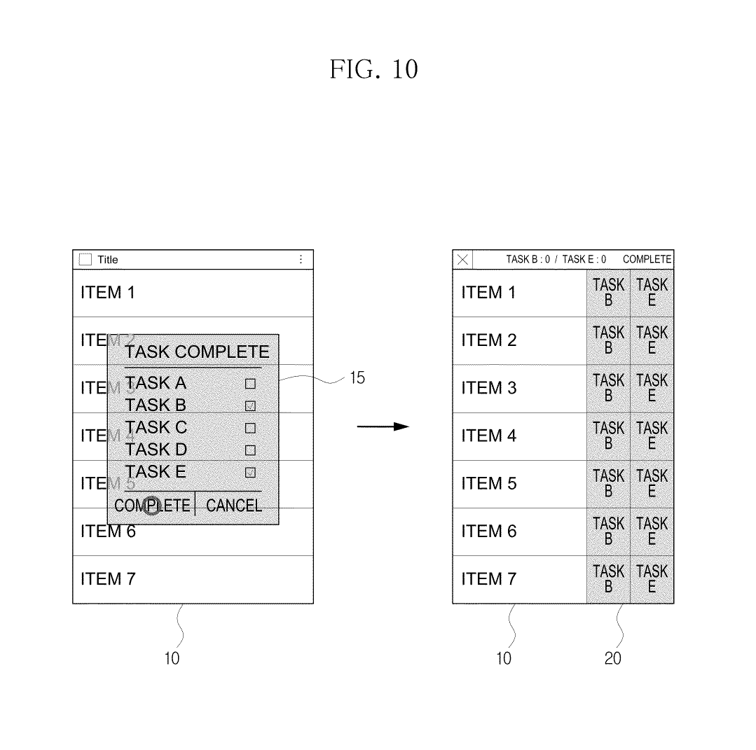

FIG. 10 is a diagram illustrating an operation for selecting task checkboxes to be displayed according to exemplary embodiments of the present invention.

Referring to FIG. 10, when one or more tasks, such as, tasks B and E, are selected by the user from a task list 15 (e.g., a task list that may represent some or all tasks that may be capable of being executed for one or more items), a task checkbox including the tasks B and E selected by the user is displayed on the second screen layer 20 and overlaid on the first screen layer 10. Further, the task list 15 may be displayed in response to a selection of a menu button.

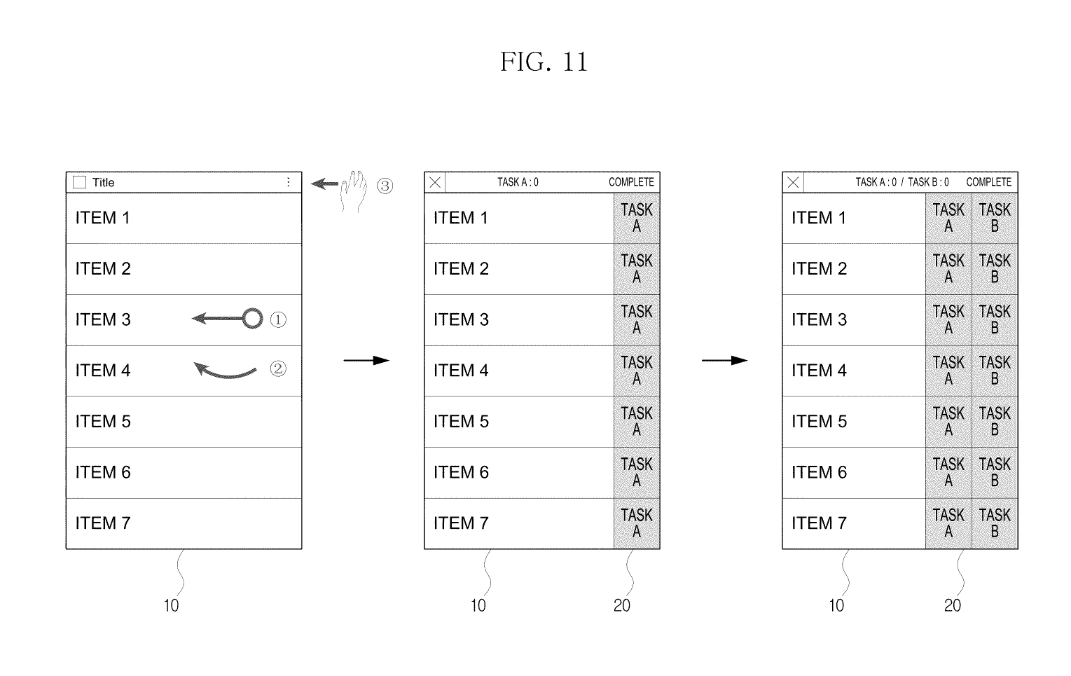

FIG. 11 is a diagram illustrating an operation to control a display of a task checkbox according to exemplary embodiments of the present invention.

Referring to FIG. 11, when the user provides a dragging motion on a portion of screen in a first direction, such as from the right to the left, with a finger or a utensil in a state where a plurality of items are displayed on the first screen layer 10 \textcircled{1}, a hidden column of task checkboxes may be dragged out to be overlaid on a portion of the first screen layer 10. Further, when the user provides another dragging motion on a portion of the screen in a second direction, is such as from the left to the right, with a finger or a utensil in a state where the column of task checkboxes is overlaid displayed on the second screen layer 20 and overlaid on the first screen layer 10, the second screen layer 20 is dragged again to be hidden from display. However, aspects of the invention are not limited thereto, such that the dragging motion may be performed in various directions.

In addition, as illustrated in FIG. 11, when the user makes an input motion, such as a swiping motion, a touch and drag motion, a flicking motion, and the like, on the screen in a first direction, such as from the right to the left, with a finger or utensil in a state where the plurality of items are displayed on the first screen layer 10 \textcircled{2}, the hidden column of task checkboxes may be displayed to be overlaid on the first screen layer 10. One or more columns of task checkboxes may be overlaid at a single instance such that the all of the hidden columns of task checkboxes may be displayed by a single swiping operation, or the columns of task checkboxes may be overlaid in increments, such that parts thereof may be sequentially displayed when the swiping operation is performed. Further, when the user makes a swiping motion on the screen in a second direction, such as from the left to the right, with a finger or utensil in a state where one or more columns of task checkboxes are displayed on the second screen layer 20 and overlaid on the first screen layer 10, the second screen layer 20 may be dragged again to be hidden. However, aspects of the invention are not limited thereto, such that the swiping motion may be performed in various directions or other input types may be provided, such as a touch and drag or a flick. Further, different input types may correspond to a different operation or the same operation.

Further, the method of overlaying or removing one or more columns of task checkboxes displayed on the first screen layer 10 through the swiping operation may be is implemented in various manners.

In addition, as illustrated in FIG. 11, when the user taps on the right portion or right side face of the terminal in the state where the plurality of items are displayed on the first screen layer 10 \textcircled{3}, one or more columns of hidden task checkboxes, which may be displayed on the second screen layer 20, may appear to be overlaid on the first screen layer 10. Some or all of the columns of task checkboxes may be overlaid at a time, such that the entirety thereof may be displayed by a single tapping operation, or the columns of task checkboxes may be overlaid incrementally such that parts thereof are sequentially shown when the swiping operation is performed. Further, when the user taps on the left portion or left side face of the terminal in the state where one or more columns of task checkboxes are displayed on the second screen layer 20 and overlaid on the first screen layer 10, at least a portion of the second screen layer 20 may again be hidden.

Further, the method of overlaying or removing one or more columns of task checkboxes on or from the first screen layer 10 through the tapping operation may be implemented in various manners.

In addition, the columns of task checkboxes may be overlaid on or removed from the first screen layer 10 by using at least one of the dragging operation, the swiping operation, and the tapping operation. However, aspects of the invention are not limited thereto, such that other operations, motions, or a combination of multiple operations/motions may be used.

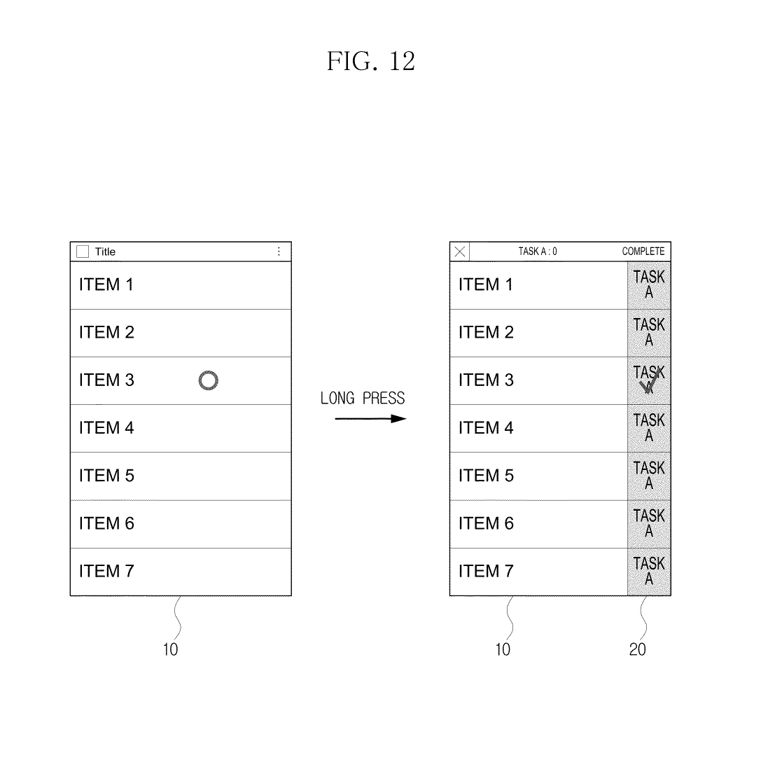

FIG. 12 is a diagram illustrating an operation to control a display of a task checkbox according to exemplary embodiments of the present invention.

Referring to FIG. 12, when the user touches or presses a part of the screen for a predetermined time or longer in a state where the plurality of items are displayed on the first is screen layer 10, a column of task checkboxes displayed on the second screen layer 20 is overlaid on the first screen layer 10. The task checkboxes may be displayed to be matched to the items. The item corresponding to coordinates at which the long touch or press input is detected may be preferentially selected and ticked. For example, press input may refer to a touch exerting pressure above a reference threshold.

As described above, when the task checkboxes are provided in response to the long touch or press input, tasks to be executed may be selected before detecting the long touch or press input or after detecting the long touch or press input.

More specifically, when the tasks to be executed are selected before the long touch or press input is detected, for example, after the tasks to be executed are first selected from a task list provided through a menu button input by the user, the task checkbox including the tasks previously selected by the user is overlaid on the first screen layer 10.

When the tasks to be executed are selected after the long touch or press input, for example, when there is a long touch or press input in a state where tasks are not selected, one or more columns of checkboxes may be displayed on the second screen layer 20 and overlaid on the first screen layer 10, such that at least one of the checkboxes are matched to the items. Further, the items may be selected by the user from the second screen layer 20, and thereafter tasks to be executed may be selected from a task list provided according to a menu button input.

As described above, one or more task checkboxes may be overlaid on the first screen layer 10 through the second screen layer 20 according to user inputs for task selection, and this may be implemented in various methods without being limited to the methods described above.

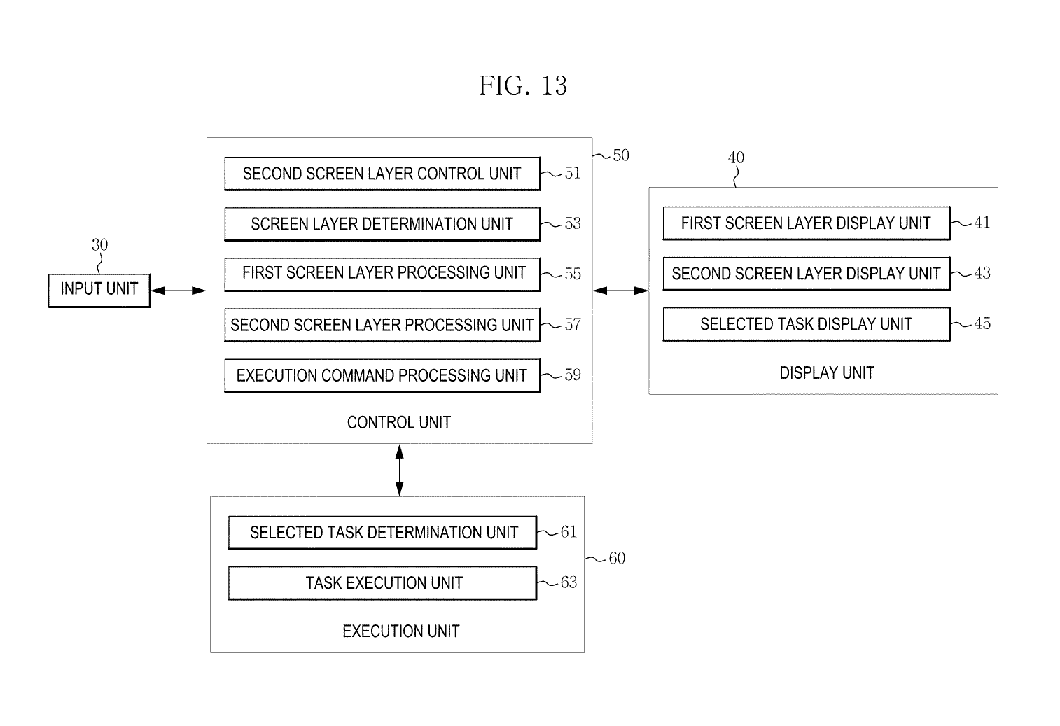

FIG. 13 is a schematic diagram illustrating a configuration of a terminal according is to exemplary embodiments of the present invention.

Referring to FIG. 13, a terminal includes an input unit 30, a display unit 40, a control unit 50, and an execution unit 60. The terminal may be, without limitation, a mobile terminal, a tablet computer, a desktop PC, a laptop PC, and the like.

In such a configuration, the input unit 30 may detect a touchscreen input of the user.

More specifically, the input unit 30 may detect an input signal corresponding to an operation action of the user performed on the touchscreen to be transmitted to the control unit 50.

The operation action of the user may include at least one of a touching operation, a swiping operation, a dragging operation, a long touch or press operation, and the like.

The input unit 30 may be configured as a thin layer provided on the front surface of the display unit 40 and may be at least one of a resistive type, a capacitive type, or the like.

The display unit 40 may display at least one of a plurality of items on the first screen layer according to the control of the control unit 50, a task checkbox to be overlaid on the first screen layer through the second screen layer such that the task checkbox may be matched to the items displayed on the first screen layer, and tasks selected from the second screen layer to be distinguished between the items. In addition, the display unit 40 may display a screen of the result of the execution of the tasks.

The display unit 40 may include a first screen layer display unit 41, a second screen layer display unit 43, and a selected task display unit 45.

The first screen layer display unit 41, the second screen layer display unit 43, and the selected task display unit 45 may be logically divided elements. The first screen layer is display unit 41 may display the plurality of items on the first screen layer according to the control of the control unit 50.

The second screen layer display unit 43 may overlay and display the one or more task checkboxes on the first screen layer through the second screen layer. The task checkboxes of the second screen layer may be overlaid on the first screen layer to be matched to the items displayed on the first screen layer according to the control of the control unit 50.

The selected task display unit 45 may display the tasks selected by the user from the second screen layer for one or more items to be distinguished from one another according to the control of the control unit 50.

The user may select tasks by touching or dragging the task checkbox displayed through the second screen layer for one or more items.

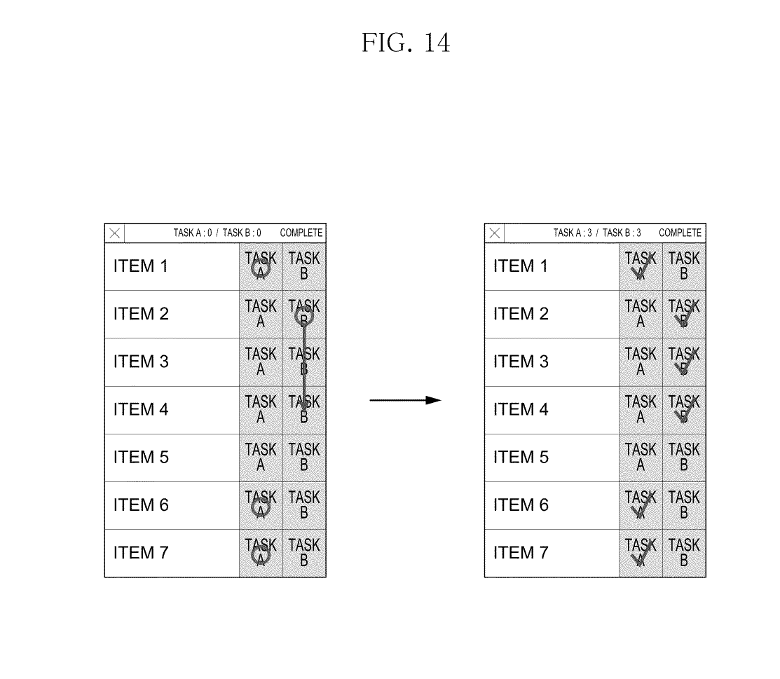

FIG. 14 is a diagram illustrating a method for selecting tasks according to exemplary embodiments of the present invention.

Referring to FIG. 14, when a task A is to be selected for items 1, 6, 7 and a task B is to be selected for items 2, 3, and 4, the task A may be selected for the items 1, 6, and 7 by independently touching the items, and the task B may be selected for the items 2, 3, and 4 by dragging a touch from the item 2, through item 3, to the item 4.

Further, the selected tasks may be deselected by a touching operation or a dragging operation.

In addition, the user may select tasks for one or more items from the second screen layer using at least one of a dragging operation and a long touch or press input.

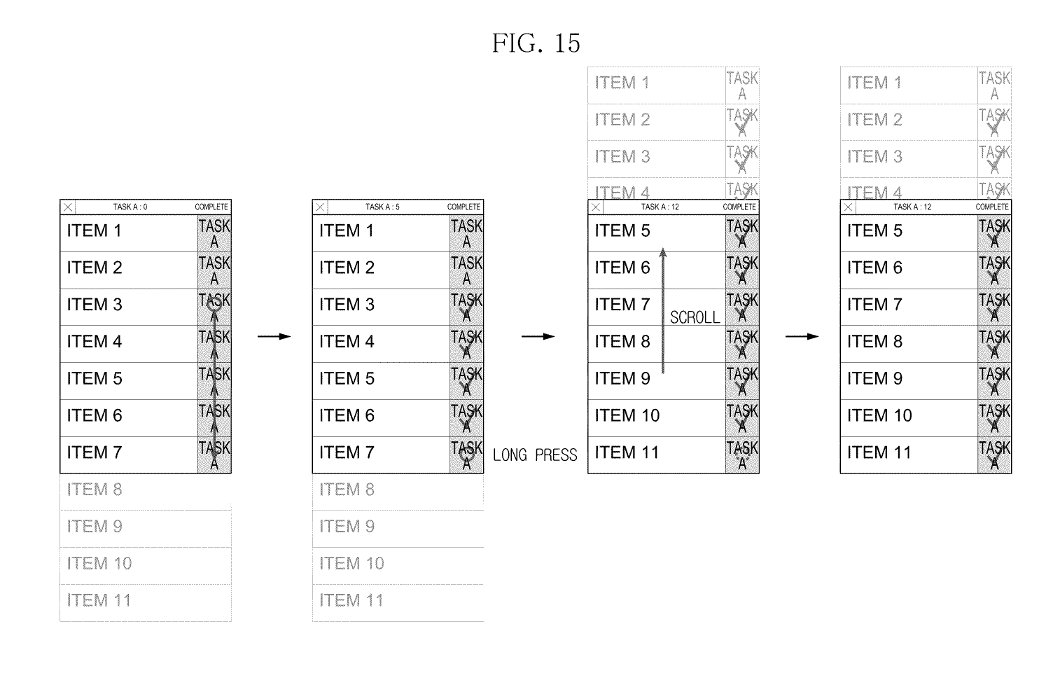

FIG. 15 is a diagram illustrating a method for selecting tasks according to exemplary embodiments of the present invention.

Referring to FIG. 15, when the user selects the task A from the second screen layer through the operation of dragging from the item 3 to the item 7, which may be the lowest displayed item on the initial screen, and maintains the touch or pressure thereon for a predetermined time or longer, the first screen layer and the second screen layer may be scrolled up in synchronization with each other such that remaining items may be displayed. Remaining items includes Item 8, Item 9, Item 10, and Item 11.

While the first screen layer and the second screen layer may be scrolled up in synchronization with each other as described above, the task A may be selected for the items scrolled up, which may include Item 8, Item 9, Item 10, and Item 11. More specifically, the screen layers may be scrolled up while the user maintains the touch or pressure, such that the screen may continue to scroll until it reaches bottom or until the user releases the touch or pressure. While scrolling, the tasks corresponding to the scrolled items will continually be selected. Accordingly, when the user removes the touch or pressure from the item 11, the task A is selected for the items 3 to 11.

In the above exemplary embodiments, a single task is described as being selected for a single item. However, aspects of the invention are not limited thereto, such that a plurality of tasks may be selected for a single item. For example, when a particular message is to be moved to not only the USIM but also the storage box, both Move to USIM task checkbox and Move to Storage task checkbox may be selected.

The selected task display unit 45 may display the tasks selected for one or more items to be distinguished. The tasks selected by the user may be displayed to be distinguished using ticks or marks, such as check marks and circles.

Referring to FIG. 14, when the task A is selected for the items 1, 6, and 7 and the is task B is selected for the items 2 to 4 through the checkboxes provided on the second screen layer by the user, the checkboxes of the task A for the items 1, 6, and 7 are ticked or marked with a checkmark or the like, and the checkboxes of the task B for the items 2 to 4 are ticked or marked with checkmarks. However, aspects of the invention are not limited thereto, such that other marks or ticks may be used.

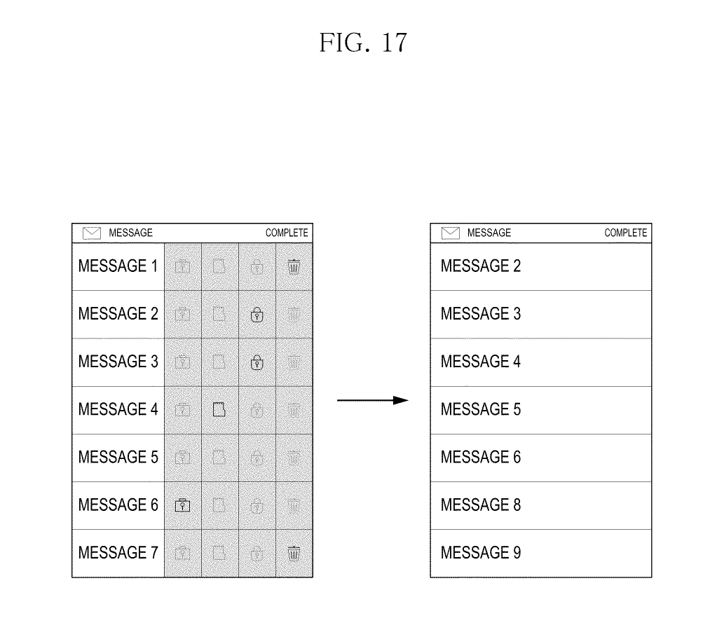

In addition, the tasks selected by the user may be highlighted to be distinguished. The tasks selected by the user may be highlighted by a certain color, shade, pattern, or the like. The selected tasks may be changed in color, shade, patter, or the like to be distinguished as illustrated in FIG. 17. For example, the brightness of the selected tasks may be more saturated to be distinguished.

The display unit 40 may be implemented as a display unit, such as a Liquid Crystal Display (LCD) or an Organic Light Emitting Diode (OLED).

When a user input for task selection is received when plurality of items are displayed on the first screen layer, the control unit 50 may control the display unit 40 to display a task checkbox to be matched to the displayed items and be overlaid on the first screen layer through the second screen layer. The second screen layer may be overlaid on the first screen layer according to the received user input.

In addition, when a user input is detected by the input unit 30 when the task checkbox is matched to the items and overlaid on the first screen layer through the second screen layer, the control unit 50 may determine the screen layer and the item where the user input is detected or received, and may control the display unit 40 to display tasks selected for the item to be distinguished on the second screen layer according to the determination result.

Referring again to FIG. 13, the control unit 50 includes a second screen layer is control unit 51, a screen layer determination unit 53, a first screen layer processing unit 55, a second screen layer processing unit 57, and an execution command processing unit 59.

When a user input for task selection is detected when the plurality of items are displayed on the first screen layer, the second screen layer control unit 51 may control the display unit 40 to display a task checkbox to be matched to the items and be overlaid on the first screen layer through the second screen layer.

The screen layer determination unit 53 may determine the screen layer at which the user input may be detected, which may include the first screen layer and the second screen layer, based on coordinates at which the user input is detected. The screen layer determination unit 53 may make such determination when the second screen layer is overlaid on the first screen layer.

When it is confirmed by the screen layer determination unit 53 that the user input detected by the input unit 30 is an input that is received on the first screen layer, the first screen layer processing unit 55 may execute a process corresponding to the user input received on the first screen layer.

More specifically, the first screen layer processing unit 55 may control the display unit 40 to scroll the first screen layer and the second screen layer in a particular direction, such as up and down or left and right, or may control the overlaid second screen layer to disappear according to the user input, which may include one of touching, swiping, dragging, and a long touch or press, that may be received on the first screen layer.

When it is confirmed by the screen layer determination unit 53 that the user input detected by the input unit 30 is an input that is received on the second screen layer, the second screen layer processing unit 57 may execute a process corresponding to the user input received is on the second screen layer.

More specifically, the second screen layer processing unit 57 may control the display unit 40 to scroll the first screen layer and the second screen layer in a particular direction, such as up and down or left and right, or display tasks selected for one or more items to be distinguished on the second screen layer according to the user input, which may include at least one of touching, swiping, dragging, and a long touch or press, that may be received on the second screen layer.

The execution command processing unit 59 may process the user input for an execution command.

More specifically, when the user input detected by the input unit 30 is about an execution command (for example, a Complete button input), the execution command processing unit 59 may apply the execution command to the execution unit 60.

The execution unit 60 may execute the tasks selected for one or more items according to the tasks selected from the second screen layer.

Referring again to FIG. 13, the execution unit 60 includes a selected task determination unit 61 and a task execution unit 63.

The selected task determination unit 61 may determine the tasks selected for one or more items based on the tasks displayed, which may be distinguished by being ticked, marked, or highlighted in the task checkbox corresponding to the items. For example, when the task A is ticked or marked for items 1, 6, and 7, and the task B is ticked for the items 2, and 3, it may be determined that the task A is selected for the items 1, 6, and 7, and the task B is selected for the items 2, and 3.

The task execution unit 63 may simultaneously execute the tasks selected for one is or more items based on the result determined by the selected task determination unit 61. For example, the task A may be executed for the items 1, 6, and 7, and the task B may be executed for the items 2, and 3, and the tasks may be simultaneously executed.

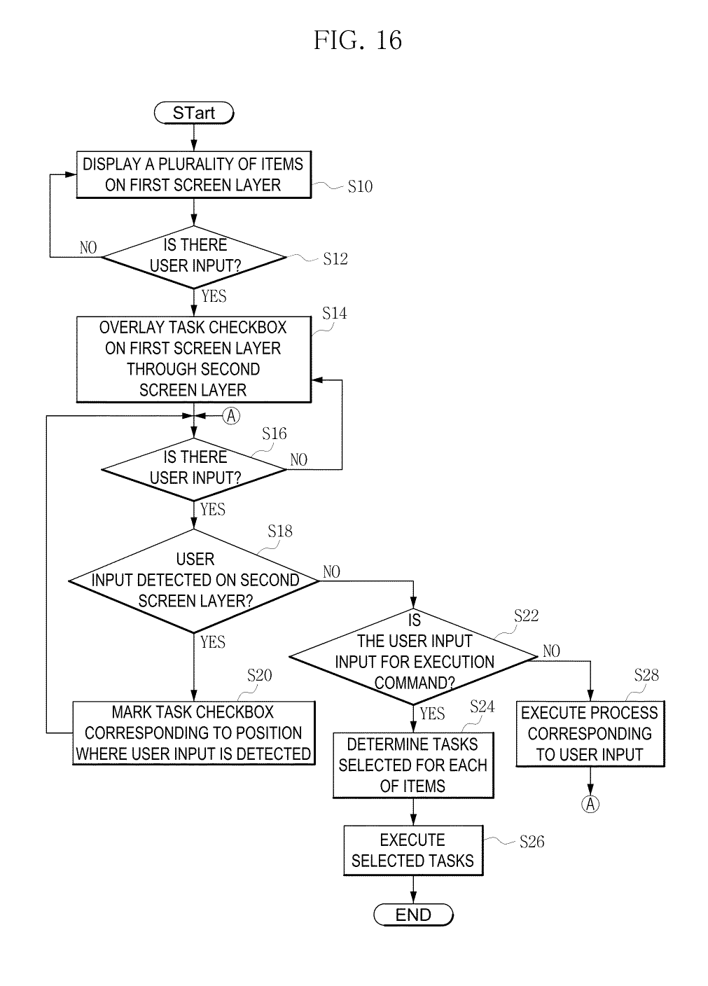

FIG. 16 is a flowchart a method for providing a user interface according to exemplary embodiments of the present invention.

In operation S10, a plurality of items is displayed on a first screen layer. In operation S12, the control unit 50 determines whether or not there is a user input for task selection.

The user input for task selection may include at least one of a menu button input, a dragging operation on the touchscreen, a swiping operation on the touchscreen, a tapping operation of the user, a long touch or press input onto the touchscreen, and the like.

When a user input for task selection is determined in operation S12, the control unit 50 may control the display unit 40 to display a task checkbox to be matched to the items and be overlaid on the first screen layer through the second screen layer (S 14).

The task checkbox may include one or more tasks overlaid in operation S14, such that different tasks may be selected for one or more items. As illustrated in FIG. 5, the task checkbox including the same number of tasks as the number of all the tasks that may be capable of being executed for one or more items may be matched to the items. Further, the task checkboxes may be overlaid on the first screen layer through the second screen layer.

In addition, when an upper task list for upper tasks, which may be grouped by similarity in function, is overlaid on the first screen layer and an upper task, for example, “Move” is selected by the user from the overlaid upper task list, a task checkbox including lower tasks that corresponds to “Move”, for example, “Move to USIM” and “Move to Storage box” is may be overlaid on the first screen layer through the second screen layer.

In addition, according to the user input for task selection, when a task list for some or all tasks that may be capable of being executed for one or more items may be overlaid on the first screen layer. Further, one or more tasks, such as tasks B and E, may be selected by the user from the overlaid task list, a task checkbox including the tasks B and E selected by the user may be overlaid on the first screen layer through the second screen layer.

In operation S16, the control unit 50 determines whether or not there is a user input when the second screen layer is overlaid on the first screen layer.

When a user input is received in the state where the second screen layer is overlaid on the first screen layer, the screen layer at which user input is received is determined between the first screen layer and the second screen layer based on the coordinates at which the user input is detected (S18).

When it is determined that the user input is received on the second screen layer, the checkboxes of the tasks corresponding to the positions where the user input is detected are ticked or marked to distinguish the selected tasks by controlling the display unit 40 (S20).

When it is determined that the user input is received on the first screen layer, it is determined whether or not the user input is an input for an execution command of the selected tasks (S22).

When the user input is determined to be an input for an execution command, the control unit 50 applies the execution command to the execution unit 60, and the execution unit 60 determines tasks selected for one or more items according to the tasks ticked or marked for the items in the task checkbox of the second screen layer according to the execution command (S24).

In addition, the execution unit 60 executes the tasks selected for one or more items at a time based on the determination result of S24 (S26).

On the other hand, when the user input is not an input for an execution command, the execution unit 60 executes a process corresponding to the user input (S28).

For example, when the user input is determined to be a user input for controlling the second screen layer to disappear in operation S28, for example, an input corresponding to an operation of dragging a portion of the screen from the left to the right by the user or an input corresponding to an operation of swiping the screen from the left to the right by the user, an operation of controlling the second screen layer overlaid on the first screen layer to disappear may be executed by controlling the display unit 40.

In addition, when the user input is determined to be a user input for scrolling the screen, for example, an input corresponding to an operation of dragging the screen upward or dragging the screen downward or an input corresponding to an operation of swiping the screen upward or swiping the screen downward, the first screen layer and the second screen layer may be scrolled up or down by controlling the display unit 40.

According to aspects of the invention, when the first screen layer and the second screen layer are scrolled according to the user input, the first screen layer and the second screen layer may be subordinate to each other such that the first screen layer and the second screen layer may be engaged and scrolled in the same manner. Otherwise, they may be scrolled independently from each other.

According to exemplary embodiments of the present invention, a plurality of tasks may be executed at a time.

According to aspects of the invention, when referring to a message, tasks related is to list management, for example, Move to Storage box, Move to USIM, Security lock, and Delete may be selectively processed at a time.

FIG. 17 is a diagram illustrating a display of checkboxes on a user interface according to exemplary embodiments of the present invention.

Referring to FIG. 17, when a user input for task selection is received in a state where a plurality of messages are displayed on the first screen layer, a task checkbox including Move to Storage box, Move to USIM, Security lock, and Delete is displayed to be overlaid on the first screen layer through the second screen layer.

Here, the tasks included in the task checkbox overlaid on the first screen layer through the second screen layer, more specifically, Move to Storage box, Move to USIM, Security lock, and Delete may be tasks grouped by similarity in function or selected by the user.

Referring to FIG. 17, when the task checkboxes including a Move to Storage box operation, a Move to USIM operation, a Security lock operation, and a Delete operation are overlaid on the first screen layer through the second screen layer, the user selects tasks to be executed for one or more of the messages from the task checkboxes of the second screen layer.

For example, the Delete operation may be selected for messages 1 and 7, the Security lock operation may be selected for messages 2 and 3, the Move to USIM operation may be selected for message 4, and the Move to Storage box operation may be selected for message 6.

The color, shade, pattern, or other attribute of the selected tasks may be displayed such that selection of the tasks selected by the user may be more distinguishable. For example, the color, shade, pattern or other attributes may be changed to be more saturated, different, or the like.

When the tasks to be executed for one or more messages are selected, the Complete button may be touched to execute the selected tasks.

In response to an execution command, the Delete operation for the message 1 and 7, the Security lock operation for the messages 2 and 3, the Move to USIM operation for message 4, and the Move to Storage box operation for message 6 may be executed. Further, these operations may be executed simultaneously or in a sequential order.

In addition, according to exemplary embodiments of the present invention, even when sending an email, an email may be designated to be sent to recipients and carbon copies may be made. Further, addressee for the email recipient and addressee for the carbon copies may be selected for sending.

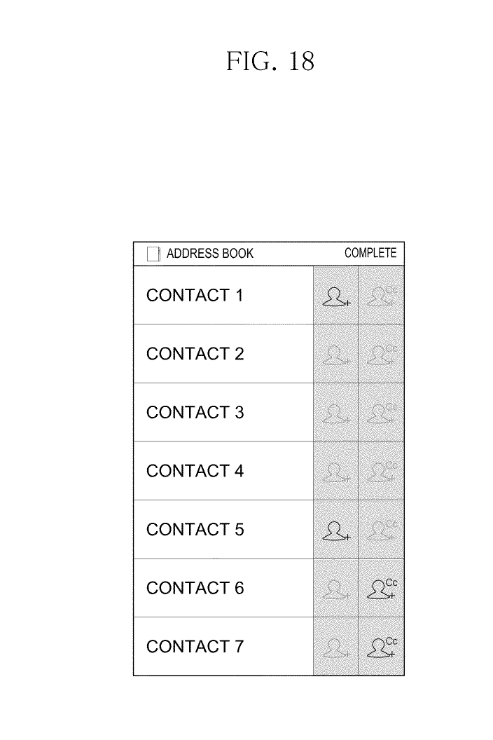

FIG. 18 is a diagram illustrating a task of designating a recipient and a carbon copy for transmission of contact information according to exemplary embodiments of the present invention.

Referring to FIG. 18, when a Send email operation is selected by the user from the task list in a state where contacts of Phonebook are displayed on the first screen layer, a task checkbox allowing selection of recipients and carbon copies is overlaid on the first screen layer through the second screen layer.

When the task checkbox allowing selection of recipients and carbon copies is overlaid on the first screen layer through the second screen layer, the user may select recipients and carbon copies from the second screen layer.

For example, contact 1 and contact 5 may be selected as the recipients and contact 6 and contact 7 may be selected as the carbon copies.

After selecting both the recipients and the carbon copies as such, the Complete is button may be touched to send an email.

In response to an execution command, the email may be sent to contact 1 and contact 5 as the recipients and to the contact 6 and contact 7 as the carbon copies.

In addition, according to exemplary embodiments of the present invention, during rotation of photographs, a Rotate right operation and a Rotate left operation may be selected to be executed. The respective operations may be selected at the same time or in a sequential order.

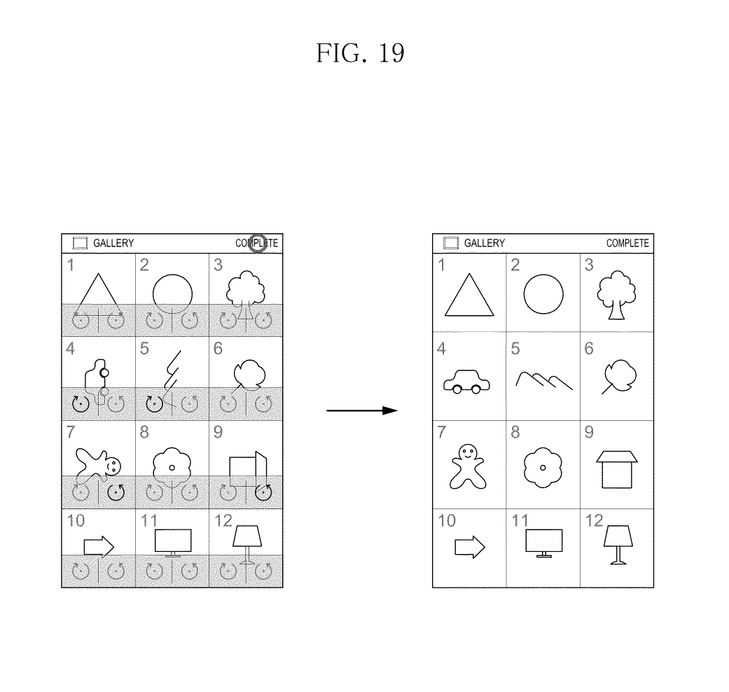

FIG. 19 is a diagram illustrating tasks capable of being performed on images according to exemplary embodiments of the present invention.

Referring to FIG. 19, when photograph rotation is selected by the user from the task list in the state where a plurality of photographs are displayed on the first screen layer, a task checkbox including the Rotate right operation and Rotate left operation may be overlaid on the first screen layer through the second screen layer.

When the task checkbox including the Rotate right operation and the Rotate left operation is overlaid on the first screen layer through the second screen layer, the user may select a direction to rotate one or more of the photographs from the second screen layer.

For example, the Rotate right operation may be selected for photograph 4 and photograph 5, and the Rotate left operation may be selected for photograph 7 and photograph 9.

After selecting rotation directions as such, the Complete button is touched to rotate the photographs.

In response to an execution command, operations of rotating the photograph 4 and photograph 5 to the right and rotating the photograph 7 and photograph 9 to the left may be executed. The respective operations may be executed at the same time or in a sequential order.

According to exemplary embodiments of the present invention, different tasks is may be applied to one or more items on a single screen. Further, one or more tasks may be executed simultaneously or simultaneously be ordered to be executed.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method for providing a user interface, the method comprising:
displaying item information of an item on a first screen layer;
displaying a first task selection menu corresponding to the item on a second screen layer; and
overlaying the second screen layer on a portion of the first screen layer while displaying the item information as a whole.

2. The method of claim 1, further comprising:
detecting an input on the user interface; and
determining whether the detected input corresponds to item information of the first screen layer or the first task selection menu of the second screen layer.

3. The method of claim 2, wherein, if the input is determined to be detected on the item information of the first screen layer, executing a command corresponding to the item information.

4. The method of claim 2, wherein, if the input is determined to be detected on the first task selection menu of the second screen layer, marking the first task selection menu for execution.

5. The method of claim 4, further comprising:
transmitting an execution command for a task corresponding to the marked first task selection menu; and
executing the task.

6. The method of claim 1, wherein the first task selection menu is displayed in response to an input.

7. The method of claim 6, wherein the input comprises at least one of a dragging operation, a swiping operation, a tapping operation, and a long touch or press operation.

8. The method of claim 1, further comprising:
grouping the first task selection menu and a second task selection menu for display,
wherein the first task selection menu and the second task selection menu are grouped together based on function.

9. The method of claim 1, further comprises:
selecting the first task selection menu and a second task selection menu for display on a task grouping menu; and
displaying the selected task selection menus.

10. The method of claim 1, further comprising:
displaying a second task selection menu,
wherein the first task selection menu and the second task selection menu are selected for execution in response to a single operation.

11. The method of claim 1, wherein the first screen layer and the second screen layer are scrolled in a first direction to display a third task selection menu in response to an operation performed at a portion of the second screen layer.

12. The method of claim 11, wherein if the first screen layer and the second screen layer are scrolled in the first direction, the third task selection menu is automatically marked for execution.

13. The method of claim 1, further comprising:
displaying a task grouping menu comprising a first task grouping menu;
selecting the first task grouping menu;
displaying the first task selection menu if the first task grouping menu is selected,
wherein the first task selection menu is grouped under the first task grouping menu based on its function.

14. The method of claim 1, further comprising:
displaying a second task selection menu to be distinguishable from the first task selection menu.

15. A terminal, comprising:
a display unit comprising a first screen layer and a second screen layer, the first screen layer displaying item information of an item, and the second screen layer displaying a first task selection menu corresponding to the item; and
a control unit to overlay the second screen layer on a portion of the first screen layer while the item information of the first screen layer is wholly displayed.

16. The terminal of claim 15, further comprising:
an input unit to detect an input.

17. The terminal of claim 16, wherein the display unit displays the first task selection menu in response to the input.

18. The terminal of claim 17, further comprising:
an execution unit to execute a command,
wherein, if the input is determined to be detected on the item information of the first screen layer, the execution unit executes a command corresponding to the item information.

19. The terminal of claim 17, wherein, if the input is determined to be detected on the first task selection menu of the second screen layer, the control unit marks the first task selection menu.

20. The terminal of claim 17, wherein the display unit displays the first task selection menu in response to the input.

21. The terminal of claim 19, further comprising:
an execution unit to execute a command,
wherein the control unit transmits a command to execute a task corresponding to the marked first task selection menu.

22. A method for providing a user interface, the method comprising:
displaying item information of an item on a first screen layer;
displaying a first task selection menu and a second task selection menu corresponding to the item on a second screen layer;
overlaying the second screen layer on a portion of the first screen layer while displaying the item information as a whole;
receiving a selection of at least one of the first task selection menu and the second task selection menu; and
executing at least one of the selected task selection menus.
